(19) United States
(12) Patent Application Publication
(10) Pub. No.: US 2025/0298596 A1
(43) Pub. Date: Sep. 25, 2025

(54) AUTOMATED GOVERNANCE AND COMPLIANCE GATING OF APPLICATION DEPLOYMENTS

(71) Applicant: DISH Network Technologies India Private Limited, Bengaluru (IN)

(72) Inventors: Yogesh Malhotra, Bengaluru (IN); Praveen Kumar Nadipi Karunakara, Bengaluru (IN); Vedam Jude Pragash, Bengaluru (IN); Shishir Pandey, Bengaluru (IN)

(21) Appl. No.: 18/958,696

(22) Filed: Nov. 25, 2024

(30) Foreign Application Priority Data
Mar. 20, 2024 (IN) 202441021200

(51) Int. Cl. G06F 21/57; G06F 8/60

(52) U.S. Cl. CPC G06F 8/61; G06F 8/71; G06F 21/57; G06F 2221/033

(57) ABSTRACT

Systems, devices, and methods related to automated management of deployment of applications are provided. An example computer system includes one or more processors and a computer-readable storage media storing computer-executable instructions. The instructions when executed by the one or more processors, cause the computer system to receive a request for deploying an application in a production environment, access data generated during continued integration/continued development (CI/CD) pipeline execution of the application, analyze the data to determine a status of the application, determine whether the application is ready for deployment based at least in part on the status of the application and a predetermined policy, and block the application from deployment in response to a determination that the application is not ready.

### CROSS REFERENCE TO RELATED APPLICATIONS

This application claims priority to Indian Provisional Patent Application No. 20/244,1021200, titled “AUTOMATED GOVERNANCE AND COMPLIANCE GATING OF APPLICATION DEPLOYMENTS,” filed on Mar. 20, 2024, in the Indian Intellectual Property Office, the disclosure of which is incorporated by reference in its entirety for all purposes. This application is also related to U.S. Patent Application No. ______ titled “AUTOMATED GOVERNANCE AND COMPLIANCE GATING OF APPLICATION DEPLOYMENTS” (P2024-05-02), U.S. Patent Application No. ______, titled “AUTOMATED GOVERNANCE AND COMPLIANCE GATING OF APPLICATION DEPLOYMENTS” (P2024-05-03), and U.S. Patent Application No. ______, titled “AUTOMATED GOVERNANCE AND COMPLIANCE GATING OF APPLICATION DEPLOYMENTS” (P2024-05-04), the disclosures of which are incorporated by reference in their entirety for all purposes.

### BACKGROUND

Deployment of a software application typically involves a sequential and multi-stage process, where the software application is released and updated through a step-by-step procedure. Conventional methods for software deployment often follows a linear trajectory, starting with building and development, progressing through validation and testing, and ultimately reaching production deployment. Developers and operations teams are involved in each stage and manage tasks such as code compilation, testing, configuration, and release. A common example of the conventional method is the use of manual deployment scripts or runbooks, where operators execute a series of predefined steps to deploy the software to production servers. However, this conventional method is prone to drawbacks and limitations. Manual interventions can lead to human errors and result in deployment inconsistencies across different environments. In addition, the process tends to be time-consuming and may cause downtime as updates are implemented. Further, the manual deployment process lacks automated decision-making and can hinder agility and scalability.

### BRIEF SUMMARY OF THE DISCLOSURE

The present disclosure provides systems, devices, and methods related to automated governance and management of application deployment. In one example, a method includes receiving, in an automated deployment management system, a request for deploying an application in a production environment, accessing, by the automated deployment management system, data generated during continued integration/continued development (CI/CD) pipeline execution of the application, analyzing, by the automated deployment management system, the data to determine a status of the application, determining, by the automated deployment management system, whether the application is ready for deployment based at least in part on the status of the application and a predetermined policy, and blocking, by the automated deployment management system, the application from deployment into the production environment in response to a determination that the application is not ready.

In some embodiments, an automated deployment management system includes a centralized control module, a security control module, an automated incident response module, a deployment time control module, a compliance control module, a reliability control module, an environment control module, an infrastructure adaptation module, a release process adherence control module, a versioning and compatibility control module, an automated rollback control module, and an interoperability control module. The versioning and compatibility control module and the interoperability control module may be combined into one module.

In some embodiments, the security control module is operable and configured to receive security scan results of the application during CI/CD pipeline execution of the application, identify one or more security issues regarding the application, calculate a security score based on the security scan results, and determine whether the security score meets a threshold specified in the re-determined policy. The application is not ready for deployment if the security score does not meet the threshold.

In some embodiments, the automated incident response module is operable and configured to receive incident data indicating presence or absence of an incident open to resolution in the production environment, analyze the incident to determine whether the incident is solved or not, and whether the application is related to the incident. The application is determined not ready for deployment if the application is related to the incident and the incident is not resolved.

In some embodiments, the deployment time control module is operable and configured to receive prime time data indicating a predetermined prime time during production operation and determine whether a scheduled deployment time of the application is within the predetermined prime time. The application is determined not ready for deployment if the scheduled deployment time of the application is within the predetermined prime time.

In some embodiments, the compliance control module is configured to receive performance data of the application tested in one or more pre-production environments during CI/CD pipeline execution, analyze the performance data to identify a violation against a predetermined quality standard specified in SLI/SLO of the application, calculate a compliance adherence score of the application, and determine whether the compliance adherence score meets a threshold specified in the predetermined policy. The application is determined not ready for deployment if the compliance adherence score does not meet the threshold.

In some embodiments, the reliability control module is configured to receive performance data of the application tested in one or more pre-production environments during CI/CD pipeline execution, calculate a reliability score based on the performance data, and determine whether the reliability score meets a threshold specified in the predetermined policy. The application is determined not ready for deployment if the reliability score does not meet the threshold.

In some embodiments, the environment control module is configured to receive environment lock data indicating a predetermined time window when the production environment is locked for deployment, determining whether a scheduled deployment time of the application is within the predetermined time window. The application is determined not ready for deployment if a scheduled deployment time of the application is within the predetermined time window.

In some embodiments, the production environment is established on a cloud-computing infrastructure. The infrastructure adaptation module is configured to receive resource usage data indicating a current availability level of infrastructure resource of the cloud-computing infrastructure, and determine a minimum level of infrastructure resource desired for the application based on the predetermined policy. The application is determined not ready for deployment if the current availability level of infrastructure resource does not meet the minimum level.

In some embodiments, the predetermined policy specifies required steps of the CI/CD pipeline execution of the application, and the release process adherence control module is configured to determine whether all of the required steps are completed. The application is determined not ready for deployment if the status of the application indicates that not all of the required steps are completed.

In some embodiments, the versioning and compatibility control module is configured to receive version data indicating a current version of each one of one or more components of the application and a latest stable version of the corresponding component, and determine a difference between the current version and the latest stable version for each one of the one or more components. The application is determined not ready for deployment if the difference is more than a predetermined number of versions specified in the predetermined policy.

In some embodiments, the automated rollback control module is configured to receive SLO/SLI of the application and test data of the application, determine presence or absence of a rollback mechanism applicable to the application based on the SLO/SLI, and determine whether the rollback mechanism has been validated based on the test data. The application is determined not ready for deployment if the rollback mechanism is absent or if the rollback mechanism has not been validated.

In some embodiments, the interoperability control module is configured to receive version data indicating a current version of each one of one or more third-party components of the application and a latest stable version of the corresponding third-party component, and determine a difference between the current version and the latest stable version for each one of the one or more third-party components. The application is determined not ready for deployment if the difference is more than a predetermined number of versions specified in the predetermined policy.

In some embodiments, the centralized control module is configured to receive a request for deployment of an application in the production environment or a change/update of an existing application deployed in the production environment, orchestrate the control of the deployment by the various modules included in the automated management system, streamline the automated process for deployment governance, calculate an overall deployment readiness score, and decide whether the overall deployment readiness score meets a predetermined threshold. The application or change/update is blocked from deployment in production environment if the overall deployment readiness score does not meet the predetermined threshold.

In another example, a computer system includes one or more processors and a computer-readable storage media storing computer-executable instructions, wherein, the instructions when executed by the one or more processors, cause the computer system to receive a request for deploying an application in a production environment, access data generated during CI/CD pipeline execution of the application, analyze the data to determine a status of the application, determine whether the application is ready for deployment based at least in part on the status of the application and a predetermined policy, and allow the application to be deployed into the production environment in response to a determination that the application is ready, and block the application from deployment into the production environment in response to a determination that the application is not ready.

In accordance with some embodiments, the present disclosure also provides a non-transitory machine-readable storage medium encoded with instructions, the instructions executable to cause one or more electronic processors of a media device to perform any one of the methods described in the present disclosure.

### BRIEF DESCRIPTION OF THE DRAWINGS

FIG. 1 is a block diagram illustrating an example communications system for automated deployment of applications, according to various embodiments of the present disclosure.

FIG. 2 is a block diagram illustrating an example of an automated orchestration and governance system, according to various embodiments of the present disclosure.

FIG. 3 is a diagram illustrating an exemplary process for automated governance of application deployment, according to various embodiments of the present disclosure.

FIG. 4 is a diagram illustrating an exemplary process for automated governance of application deployment by implementing a centralized control module of the automated orchestration and governance system, according to various embodiments of the present disclosure.

FIG. 5 is a diagram illustrating an exemplary process for automated governance of application deployment by implementing a security control module of the automated orchestration and governance system, according to various embodiments of the present disclosure.

FIG. 6 is a diagram illustrating an exemplary process for automated governance of application deployment by implementing an automated incident response module of the automated orchestration and governance system, according to various embodiments of the present disclosure.

FIG. 7 is a diagram illustrating an exemplary process for automated governance of application deployment by implementing a deployment time control module of the automated orchestration and governance system, according to various embodiments of the present disclosure.

FIG. 8 is a diagram illustrating an exemplary process for automated governance of application deployment by implementing a compliance control module of the automated orchestration and governance system, according to various embodiments of the present disclosure.

FIG. 9 is a diagram illustrating an exemplary process for automated governance of application deployment by implementing a reliability control module of the automated orchestration and governance system, according to various embodiments of the present disclosure.

FIG. 10 is a diagram illustrating an exemplary process for automated governance of application deployment by implementing an environment control module of the automated orchestration and governance system, according to various embodiments of the present disclosure.

FIG. 11 is a diagram illustrating an exemplary process for automated governance of application deployment by implementing an infrastructure adaptation module of the automated orchestration and governance system, according to various embodiments of the present disclosure.

FIG. 12 is a diagram illustrating an exemplary process for automated governance of application deployment by implementing a release process adherence control module of the automated orchestration and governance system, according to various embodiments of the present disclosure.

FIG. 13 is a diagram illustrating an exemplary process for automated governance of application deployment by implementing a versioning and compatibility control module of the automated orchestration and governance system, according to various embodiments of the present disclosure.

FIG. 14 is a diagram illustrating an exemplary process for automated governance of application deployment by implementing an automated rollback control module of the automated orchestration and governance system, according to various embodiments of the present disclosure.

FIG. 15 is a diagram illustrating an exemplary process for automated governance of application deployment by implementing an interoperability control module of the automated orchestration and governance system, according to various embodiments of the present disclosure.

FIG. 16 is a flow diagram illustrating an example method for automated deployment management, according to various embodiments of the present disclosure.

### DETAILED DESCRIPTION OF THE DISCLOSURE

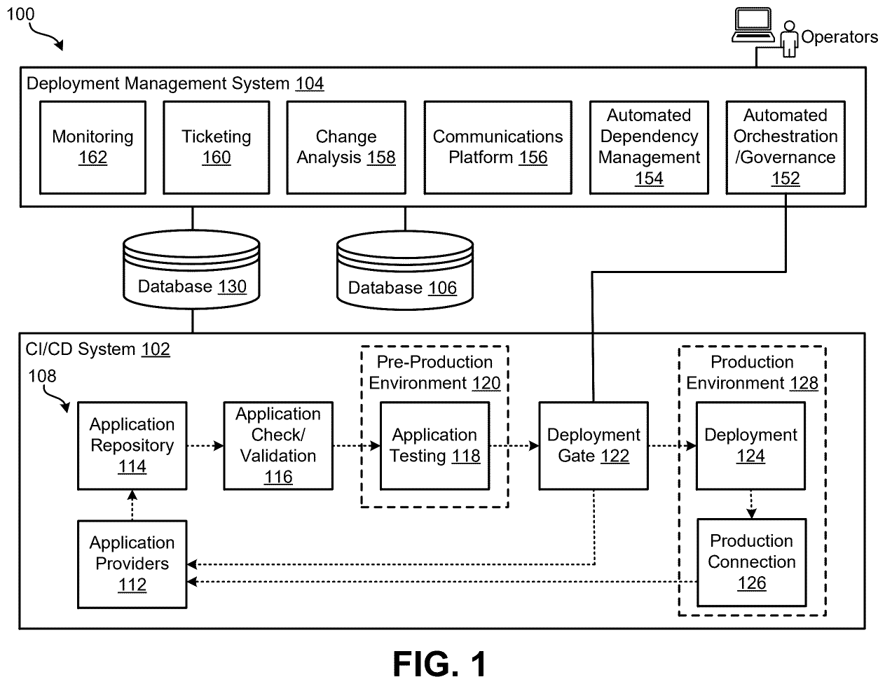

FIG. 1 is a block diagram illustrating an example communications system 100 for deployment of software applications (hereinafter “applications”) in a software development environment. In the illustrated example, communications system 100 includes, among other components, a continuous integration/continuous deployment system 102 (hereinafter “CI/CD system 102”), a deployment management system 104, and a database 106. Each component included in the communications system 100 may be a hardware component, a software component, or a combination of both hardware and software. Additional or fewer components may be included in the communications system 100. The CI/CD system 102 is generally responsible for deployment of applications through CI/CD pipeline execution. The deployment management system 104 is in communication with the CI/CD system 102 and is operable to allow operators to manage the deployment process of an application through execution of a CI/CD pipeline for the application, monitor the status of CI/CD pipeline execution of a software application, access various application data sources from database 130, determine whether the software application is ready for release, and control block or release of the application through a deployment gate 122 of the CI/CD system. In some embodiments, the deployment management system 104 may be integrated with the CI/CD system 102 to form a single system that includes the components of both.

The CI/CD system 102 further includes, among other components, application providers 112, application inventory 114 (also referred to as “application inventory”), application check and validation system 116, application testing system 118, deployment gate 122, deployment execution system 124, production connections 126, and database 130. Application providers 112 are entities or services that supply the necessary application packages, application artifacts, codes, application configuration data, service applications, docker images, dependencies, or updates of applications to the CI/CD system 102. Application providers 112 may also supply external libraries, third-party components, or internal dependencies for the development and deployment process. In some embodiments, application provider 112 may be an individual software vendor (ISV). In some embodiments, the CI/CD system 102 is automatically triggered to initiate execution of a CI/CD pipeline 108 for deployment of an application upon receiving a request for deploying the application or a request for a change/update/modification to an application.

The application inventory 114 is a centralized storage system where source codes, artifacts, and other relevant files are stored, classified, organized, and maintained. In some embodiments, the application inventory 114 serves as a version-controlled repository and is configured to track, monitor, manage, and update changes to the application codes and make the application codes accessible to the CI/CD system 102 and any components thereof for automated integration and deployment. Version data of the application and any components thereof may be stored in database 130.

The application check validation system 116 is generally responsible for conducting checks, verifications, and validations on the application artifacts before they progress further in the CI/CD pipeline 108. The application check validation system 116 may further include various modules such as code quality assessment module, security scan module, security check module, sentinel check module, dependency check module, environment lock module, metrics and reports module, among others.

For example, the code quality assessment module may be configured to utilize static code analysis tools to evaluate the overall quality of the application artifact according to predetermined standards for maintainability, readability, and adherence to coding standards. The security scan module is configured to conduct security scans on the codebase of the application artifact to identify vulnerabilities, potential exploits, and adherence to security best practices, based on predetermined standards. The security check module is configured to check the security-related aspects of the codebase, including authentication mechanisms, encryption protocols, and secure coding protocols. The sentinel check module is configured to implement automated validation routines or scripts to assess whether the predefined conditions or criteria are met before allowing the application artifacts to proceed further in the CI/CD pipeline 108.

The dependency check module is configured to analyze and validate dependencies within an application. Dependencies may include external libraries, frameworks, modules, or other components on which the application relies. In some embodiments, the dependency check module is configured to analyze the dependencies declared or utilized by the application, verify the compatibility of the dependencies with a target environment, check whether the dependencies of the application conform to version requirements, check whether the dependencies adhere to licensing requirements and organizational policies, check the overall health of dependencies. The dependency check module may generate output with outcomes of the dependency check. Dependency data of an application is stored in database 130.

The environment lock module is generally responsible for managing and enforcing locks on different environments during the deployment process. The environment lock module may be configured to identify different deployment environments, such as development, testing, and production, where application artifacts move through the CI/CD pipeline 108, implement a locking mechanism that can be applied to each environment individually, support time-based locks to allow the definition of specific time intervals during which an environment is locked, and monitors the status of environment locks in real-time. Environment lock data is stored in database 130.

The metrics and reports module is generally responsible for collecting, analyzing, and presenting relevant metrics and reports related to the deployment process through the CI/CD pipeline 108. The metrics and reports module may be configured to collect various data and output reports from other components within CI/CD system 102, define and track metrics that are aligned with predetermined criteria, utilizes automated analysis tools to process the collected data and derive insights, generate and manage reports based on the analyzed metrics, and present metrics and insights in a visually accessible format, such as charts, graphs, and dashboards. Performance metrics data is stored in database 130.

The application testing system 118 is generally responsible for testing the application artifacts in pre-production environment 120 before deployment in the production environment 128. The application testing system 118 may be configured to generate and configure testing environments, executing test instances of the application artifact in the configured testing environments, monitoring the testing, and generating outcome (e.g., testing report). A test environment used herein refers to a controlled and isolated setup that mimics the production environment to conduct application testing and validate the functionality, performance, and reliability of a software application. Execution of test instances includes the execution of a specific set of test cases designed to validate certain aspects of the application, such as functionality, performance, or security. Each test instance may be conducted in isolation to focus on a specific aspect of the application. Input data specific to a test environment may be used to simulate realistic conditions and interactions with the application. Expected outcomes may be determined based on the test case specifications, and the actual outcomes during execution may be compared against the expected outcome to determine whether the application passes the testing. Testing and validation data of an application is stored in database 130.

The deployment gate 122 is the final gate before deploying the application in the production environment 128. The deployment gate 122 is controlled by the deployment management system 104 to verify that the application has undergone required validation and testing, including but not limited to checking the validation status, checking for successful execution of test cases, meeting quality standards, and/or addressing any identified defects or deficiencies. The deployment gate 122 is further configured to execute an instruction to release or block release of the deployment based on determinations whether all predetermined requirements for deployment are met. These requirements may cover functional correctness, performance, security, reliability, and compliance with predetermined or pre-established policies and standards. If the application passes all validation and testing checks, and if all predetermined requirements are met, the deployment gate 122 allows the release of the application to the production environment 128. If any issues are identified during the validation process or if predetermined requirements are not met, the deployment gate 122 holds the release of the application.

In some embodiments, the deployment gate 122 is controlled by the deployment management system 104 to allow or hold the release of the application based on a release readiness score. A release readiness score used herein refers to a quantitative or semi-quantitative measure or numerical representation that assesses the overall readiness of an application release for deployment to a production environment. The release readiness score may be determined through evaluation of various factors, including the outcomes of validation and testing processes, adherence to predefined requirements, and other relevant criteria. The release readiness score may be determined by the deployment management system 104, based on various analytical data such as the outcomes of validation and testing or relevant reports, to calculate the release readiness score. For example, a threshold release readiness score may be established and used as a standard or reference, and only the application with a release readiness score of or above the threshold release readiness score may be released by the deployment gate 122 to the production environment 128.

The deployment execution system 124 is generally responsible for executing deployment instance of the application released to the production environment and exposing the application to production connections 126. The deployment execution system 124 may coordinate with production connections 126 to integrate the deployed application with other systems, services, and components within the production environment 128. The deployment execution system 124 may also configure the production environment 128 (e.g., update configuration files, adjust database settings, etc.) to accommodate the released application. The production environment is established on an infrastructure. In some embodiments, the production environment is established on a cloud-computing platform.

The database 130 further includes various application data sources related to the to-be-deployed application and the data generated during the CI/CD pipeline execution of the application. For example, the database 130 may include SLI/SLO/SLA data, environment lock data, reliability index data, prime time data, security data, compliance data, among others. Service Level Indicators (SLIs) are specific metrics that quantify the performance of a service, such as latency, error rate, and throughput. Service Level Objectives (SLOs) are the target values or ranges for these indicators that define the expected level or quality of service performance for the to-be-deployed application. Environment lock data indicates the status of different environments (e.g., development, testing, staging, production) and whether they are currently locked or available for deployments. Reliability index data includes metrics related to the reliability and stability of the application, such as system uptime, failure rates, and mean time to recovery (MTTR). Prime time data includes information about critical periods when deployments are restricted to avoid disruptions, such as times of high user activity from historical analysis and predetermined critical times. Security data includes information from various security scans and assessments and identified vulnerabilities and threats within the application. Compliance data includes information related to regulatory and internal compliance requirements that the application must adhere to. The deployment management system 104 and various modules included therein may access the data from the database 130 and use the data to determine whether the application is ready for release.

In the illustrated example of FIG. 1, the deployment management system 104 may further include, among other components, an automated orchestration and governance system 152, an automated dependency management system 154, a communications platform or hub 156, a change/update analysis system 158, a ticketing system 160, and a deployment monitoring system 162.

At a high level, the automated orchestration and governance system 152 is generally responsible for coordination and control over the release and deployment processes to ensure smooth, reliable, and secure delivery of application. In some embodiments, the automated orchestration and governance system 152 is configured to receive validation and testing outcomes of the application through the CI/CD pipeline 108 and generated by the CI/CD system 102, analyze the validation and testing outcomes, and determine whether the application is ready to release (e.g., calculating the release readiness score). The automated dependency management system 154 is generally responsible for identifying changes in components within an application and assessing their impact on the entire application ecosystem, utilizing automated mechanisms to facilitate a dependency management process.

At a high level, the communications platform 156 includes various interfaces for facilitating communications (e.g., message flow, data and file transfer, input, output, etc.) between the deployment management system 104 and the CI/CD system 102 as well as between the deployment management system 104 and operators. The communications platform 156 may include, among others, a natural language interface that provides a platform for the operators to query current and past states of the CI/CD system 102, obtain information about impact analysis of any changes or updates introduced by an application, and set up alerts and create periodic reports.

At a high level, the application change/update analysis system 158 is generally responsible for analyzing and providing insights into the changes and updates made to the application and all dependent applications. The application change/update analysis system 158 may be configured to conduct cost analysis, resource optimization, and predictive modeling. The change/update analysis system 158 may be configured to incorporate advanced features for identifying, validating, and securing modified components within the application slated for deployment. The application change/update analysis system 158 is further configured to determine the validations and tests required for deployment of a change/update to an application and the validations and tests required for all dependent or impacted applications associated with the software application.

At a high level, the ticketing system 160 serves as a central platform and is generally responsible for managing and tracking various activities, requests, incidents and issues related to application changes and deployments. The deployment monitoring system 162 is generally responsible for monitoring deployments in real-time and providing immediate visibility into the status and progress of each deployment, detecting errors or issues during the deployment process, generating deployment data (e.g., monitoring/logging/tracing (MELT) data), and tracking dependencies between different components of the application as well as upstream and downstream applications.

The database 106 may include various databases for storing the data received in and generated by the CI/CD system 102 and the deployment management system 104. The database 106 may include a relational database service (RDS) for storing and retrieving structured data where relationships between different data elements need to be maintained, a graph database for storing dependency graph data, a vector database, a MELT database for storing and managing data related to metrics, events, logs, traces related to a specific application or a specific infrastructure, a documentation database for storing and managing code documentation, infrastructure documentation, and other relevant information, a reliability database for storing reliability score data for applications.

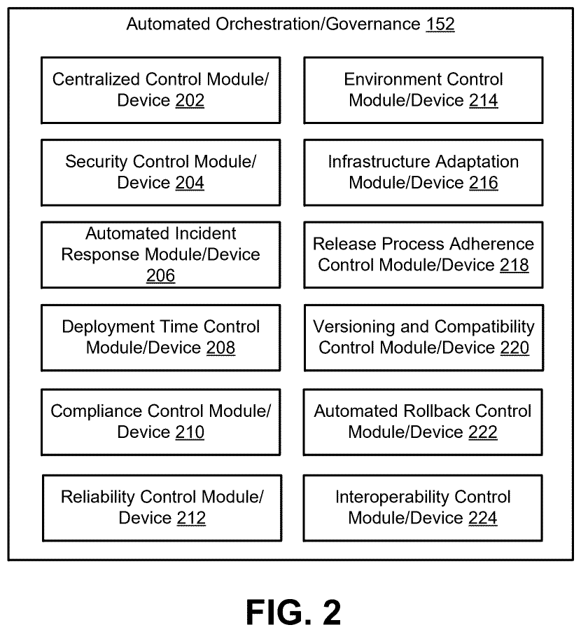

FIGS. 2-14 illustrate examples of automated orchestration and governance system 152 of the deployment management system 104 and examples for implementation of the various modules included in the system 152 for governance of the application deployment. FIG. 2 is a block diagram illustrating an example of automated orchestration and governance system 152, according to various embodiments of the present disclosure. In the illustrated example, the automated orchestration and governance system 152 includes, among other components, a centralized control module 202, a security control module 204, an automated incident response module 206, a deployment time control module 208, a compliance control module 210, a reliability control module 212, an environment control module 214, an infrastructure adaptation module 216, a release process adherence control module 218, a versioning and compatibility control module 220, an automated rollback control module 222, and an interoperability control module 224. The term “module” used herein refers to a modular and self-contained component or unit, often with defined inputs and outputs, configured to perform a specific function or set of related functions within a larger system. A module can be composed of hardware components, application code, or a combination of both. In some embodiments, the module described here is a device comprising a hardware component and a software component designed to perform the intended function of the module. Thus, as an example, the centralized control module 202 may be a centralized control device 202.

The centralized control module 202 provides a central platform for operators and allows the operators to govern all deployments across pre-production environments 120 and determine whether deployments are ready for production. An “operator” refers to an individual or a team responsible for the deployment, maintenance, and overall operational aspects of applications. Operator encompasses various roles, including but not limited to DevOps teams facilitating collaboration between development and operations, Site Reliability Engineers (SRE), system administrators, network operators, cloud operations teams optimizing application deployment in cloud environments, release managers coordinating application updates, environment management teams responsible for consistency in development environments, security operations teams focusing on security aspects, quality and compliance team, and change management team.

In some embodiments, the centralized control module 202 is integrated with the ticketing system 160. For example, once a change request ticket for changing/updating an application is generated by the ticketing system 160, the centralized control module 202 is automatically triggered to initiate monitoring and governing the deployment process of the change/update of the application. The change/update of the application may be checked, validated, tested, and deployed in the CI/CD system 102 through the CI/CD pipeline 108 for the application. The centralized control module 202 may receive various data, such as application data sources (e.g., code sources, SLI/SLO/SLA, artifact, docker image, etc.), validation outcome for each validation case and testing outcome for each test case, security data, environment lock data, reliability index data, prime time data, compliance data, incident status data, performance metrics data, application code and configuration data, application dependency data, application version data, third-party component version data, infrastructure usage data, production operation calendar, scaling/event calendar, infrastructure resource allocation schedule, rollback mechanism, disaster recovery mechanism, change impact data, among others. The centralized control module 202 may analyze the data, make a determination on the readiness of the change/update of the application before it is deployed in the production environment 128, and control the deployment gate 122 based on the determination of the readiness. As mentioned above, the centralized control module 202 is configured to calculate and determine a release readiness score for the to-be-deployed application, based on analytical data such as the outcomes and results of validation and testing or relevant reports related to the application generated during the CI/CD.

The security control module 204 is configured to receive and analyze security check/scan results (e.g., a security check outcome or report) of the application in the CI/CD system 102, identify/verify potential vulnerabilities within the application, assess the severity of vulnerabilities against a predetermined standard. When critical vulnerabilities are determined, the security control module 204 takes a proactive approach by preventing the release from progressing into the production environment 128. Example security check tools used for performing the security check on the application include but are not limited to static application security testing tools, dynamic application security testing tools, software composition analysis tools, container security tools, infrastructure as code (IaC) security tools, secrets scanning tools, dependency scanning tools, code analysis and linters, among others.

In some embodiments, security control module 204 is configured to identify and determine the component of the application associated with the identified vulnerabilities. For example, the security control module 204 may correlate vulnerabilities from different scans based on shared metadata, such as affected files or components, associate/map each identified vulnerability with the specific component, module, or file within the application using the correlated data, optionally assign priority to the identified vulnerabilities, and generate and send notifications to relevant stakeholders with information on the affected components of the application and the security posture of the affected components.

In some embodiments, the security control module 204 may classify/prioritize the identified vulnerabilities based on the criticality. In some embodiments, the security control module 204 may generate a security score that represents the overall security level or risk severity level for the application, based on the results of all security checks/scans performed within the CI/CD pipeline. The security control module 204 may indicate that the application is secure to be released to the deployment environment if the security score is of or above a predetermined threshold security score. The threshold security score may also be a component of the release readiness score.

The automated incident response module 206 is responsible for implementing automated mechanisms to check for incident of the application and control release of the application based on the incident check. In some embodiments, the automated incident response module 206 is configured to assess the occurrence of incidents within the application and exert control over the release process based on incident checks. For example, the automated incident response module 206 may continuously monitor the status of incidents within the application and associated infrastructure. The automated incident response module 206 may specifically identify critical incidents that have been reported and are currently open for resolution. Critical incidents are those that have a significant impact on the operation or performance of the application. Upon identifying critical incidents, the automated incident response module 206 makes a decision to either allow or block the release of the application. If there are critical open production incidents, the automated incident response module 206 permits the deployment of releases that specifically address and resolve the identified incidents. On the other hand, the automated incident response module 206 enforces a block on all other releases that do not directly address the critical incidents. The automated incident response module 206 may communicate the status of critical incidents to relevant stakeholders and prevent the introduction of changes that could exacerbate or complicate existing critical incidents. In some embodiments, the automated incident response module 206 may prioritize releases based on their relevance to incident resolution (e.g. assigning higher priority to releases for addressing more critical issues).

The deployment time control module 208 is configured to implement automated mechanisms for regulating and monitoring deployments, especially during prime time, to prevent disruptions and uphold a positive customer experience. In some embodiments, the deployment time control module 208 may be integrated with a production deployment calendar, which schedules deployments and events. The deployment time control module 208 may identify critical events, such as sports events or large-scale viewing campaigns, during prime time, provide configurable parameters to adapt to varying definitions of prime time or critical events, dynamically generate block events to signal periods when deployments are restricted to avoid interference with critical activities. During prime time, the deployment time control module 208 enforces restrictions on deployments.

The compliance control module 210 is configured to implement an automated mechanism for monitoring and controlling application releases in the event of violations of Service Level Indicators (SLI), Service Level Objectives (SLO), and Service Level Agreements (SLA). The compliance control module 210 may be integrated with the deployment monitoring system 162 (e.g., integrated performance observability probes) to collect real-time performance data about the performance metrics of the application deployed in the pre-production environment 120 and/or the production environment 128. The compliance control module 210 may analyze the real-time performance data to detect and identify a violation against the predetermined quality standard specified in the SLI/SLO/SLA. In some embodiments, the compliance control module 210 may analyze the real-time performance data and classify the violations into categories based on the severity/criticality of the affected function associated with the violation specified in the performance metrics, assign priorities to the violations, calculate a compliance/adherence score for the application based on the real-time performance data, and compare the compliance/adherence score with a predetermined threshold score. A compliance/adherence score of or above the predetermined threshold score may indicate a violation. The value of the compliance/adherence score may also indicate the level of significance of the violation. The compliance/adherence score may be a component of the release readiness score. In some embodiments, the compliance control module 210 may calculate the compliance score based on the outcome of the tests carried out in pre-production environments 120 to allow the module to identify potential issues before release into the production environment.

If violations of predefined SLI/SLO/SLA are identified during the monitoring process, the compliance control module 210 may flag these instances as potential risks to service quality. In the presence of violations, the compliance control module 210 may enforce a block on deployments into the production environment. The compliance control module 210 may further conduct analysis to identify the root causes of the violation, identify the component of the application associated with the violation, and identify the stakeholders responsible for the identified component and/or the associated violation.

In some embodiments, the compliance control module 210 may monitor the application during soak testing in a multi-cluster deployment setup, obtain performance metrics of the soak testing (e.g., response times, resource utilization, and other relevant indicators), evaluate the functional performance of the application under sustained load, compare the obtained results against predefined SLI/SLO to assess whether the application meets the expected standards for performance and reliability. The information gathered during soak testing may be used to inform the decision-making process for production deployment. If SLO violations are significant, the compliance control module 210 may enforce a block to cause the deployment gate to prevent release of the application into the production environment.

The reliability control module 212 is configured to implement an automated mechanism for assessing and governing application releases based on a reliability index or score, with the primary goal of preventing the deployment of applications with low reliability. Similar to the compliance control module 210, the reliability control module 212 may be integrated with the deployment monitoring system 162 (e.g., performance observability probes) to access real-time data on the reliability performance of the application in the pre-production environment 120 and/or the production environment 128. The reliability control module 212 may calculate a reliability score based on the real-time data and establish a threshold reliability score, defined by the minimum acceptable level of reliability for application releases. If the calculated reliability score falls below the predefined threshold, the reliability control module 212 initiates a warning mechanism. For example, the reliability control module 212 may issue three successive warnings to alert stakeholders about the decreasing reliability. The reliability score may be calculated based on observed metrics, including but not limited to system uptime, error rates, and other relevant indicators that contribute to the overall reliability performance. For example, the reliability control module 212 may compare the calculated reliability score against the predetermined threshold score to determine presence or absence of a reliability issue (e.g., the calculated score lower than the threshold score indicates presence of the reliability issue). Each time a reliability issue is determined, the reliability control module 212 issues a warning and notifies the stakeholder of the warning. If the reliability score continues to deviate from the desired threshold after three warnings, the reliability control module 212 takes a decisive action by blocking further releases. The fourth warning serves as a signal to prevent deployments until reliability issues are addressed. The reliability score may be a component of the release readiness score.

The environment control module 214 is configured to facilitate centralized management and control of application releases in different environments and/or availability zones. The environment control module 214 can implement an automated mechanism to enable environment managers to regulate the release process. One of the automated mechanisms is the ability to impose time-based restrictions or blocks on specific environments or availability zones. The blocks can be tailored to apply to an individual zone or entire environment.

In some embodiments, the environment control module 214 is configured to create windows during which specific activities, such as deployment of changes/upgrades to applications or infrastructures or testing of applications in a specific environment or an availability zone, can take place. By enforcing these time restrictions, the environment control module 214 can control changes introduced into each environment to preserve the integrity and reliability of the environments.

In some embodiments, the environment control module 214 may cause the deployment gate 122 to selectively allow releases of an application to a predetermined availability zone (AZ) of a cloud computing region. An availability zone used herein refers to a distinct, physically separate location within a data center or cloud infrastructure that is designed to be isolated from failures in other zones. In some embodiments, the environment control module 214 may cause the deployment gate 122 to disable deployment release to a selected availability zone within a specified time window. In some embodiments, the environment control module 214 may cause the deployment gate 122 to only enable deployment release of selected applications to an identified availability zone within a specified time window but to disable deployment releases of other applications to the availability zone within the specified time window.

The infrastructure adaptation module 216 is configured to dynamically and adaptively control deployment of applications in response to dynamic changes in infrastructure, particularly when the production environment is a cloud computing environment. The infrastructure adaptation module 216 can respond to events such as scaling events, updates, and changes in cloud computing environments. For example, when the infrastructure of a cloud computing environment where an application has been released undergoes scaling events (such as increasing or decreasing resources), updates (such as software patches or new releases), or changes in cloud environments, the infrastructure adaptation module 216 may take responsive actions to adapt the deployment and maintain stability. The responsive actions may include adjusting resource allocations, orchestrating the deployment of updates, or handling configurations to accommodate the changing infrastructure landscape.

The release process adherence control module 218 is responsible for monitoring and enforcing adherence to established processes during the change release process. The release process adherence control module 218 is configured to check change requests created in the ticketing system 160, and verify compliance with predetermined steps for deployments, including the production deployment, lower environment testing and validation, change/update details, rollback mechanisms, and other specified criteria. For example, the release process adherence control module 218 may be automatically triggered, in response to a change request ticket (e.g., a Jira ticket) generated by the ticketing system 160, to check whether the change request satisfies required Jira nomenclatures, including team and service component usage, appropriate labeling of releases, the inclusion of test results, and CI/CD pipeline details within the change request.

In some embodiments, the release process adherence control module 218 is configured to cross-validate a change/update to an application before the change is released to the production environment. For example, once the change/update to the application undergoes validation and testing according to a predetermined process (e.g., preconfigured validation or testing script), the release process adherence control module 218 may obtain the validation and testing results and performs cross-validation to confirm that the validation and testing adhered the predetermined process.

In some embodiments, the release process adherence control module 218 is configured to perform cross-validation of a change or update to an application before its release to the production environment. After the change or update undergoes validation and testing according to a predetermined procedure, such as a preconfigured validation or testing script, the release process adherence control module 218 obtains the validation and testing results and conducts cross-validation to ensure that the validation and testing procedures adhered to the predetermined process.

The versioning and compatibility control module 220 is configured to control versioning of components/services of the application and compatibility among different components/services associated with an application, particularly in environments with diverse libraries and toolsets. The versioning and compatibility module 220 may track and govern the version of each one of the libraries and components associated with the application in use and cross-check the versions against the latest stable release versions of libraries and components available. If the application being assessed is found to be behind a defined threshold, for example, n-2 versions behind the latest version available, the versioning and compatibility module 220 may enforce a block and cause the deployment gate 122 to prevent further releases of the application after issuing three warnings.

The automated rollback control module 222 is configured to verify that the application has an automated rollback or disaster recovery mechanism before release to the production environment. In some embodiments, before a change/update to an application is to be released to the production environment, the automated rollback control module 222 may identify the components/units of the application that may be affected by the change/update, check whether each affect component has a rollback mechanism in place, verify that that the rollback mechanisms are efficient to roll back all the affected components. In some embodiments, the automated rollback control module 222 may further assess the blast radius of the application. If a rollback or disaster recovery mechanism is not in place and tested in lower environments, the automated rollback control module 222 may enforce a block and cause the deployment gate 122 to prevent the release of the change/update from progressing into the production environment.

The interoperability control module 224 is generally responsible for integrating deployment with third-party components/units, third-party libraries, external services, and external Application Programming Interfaces (APIs), and managing version compatibility, authentication, and changes in third-party dependencies. In some embodiments, the interoperability control module 224 is configured to track and regulate the usage of third-party APIs and open-source libraries associated with the application, perform a cross-comparison of third-party dependencies with the latest stable and secure versions available, and determine whether the versioning and compatibility of the third-party components of the application meets a predetermined threshold level. For example, if the third-party component is determined to be n-x versions behind the latest stable releases, the interoperability control module 224 may issue warnings. After three warnings, the interoperability control module 224 may enforce a block and cause the deployment gate 122 to prevent the release from progressing into the production environment.

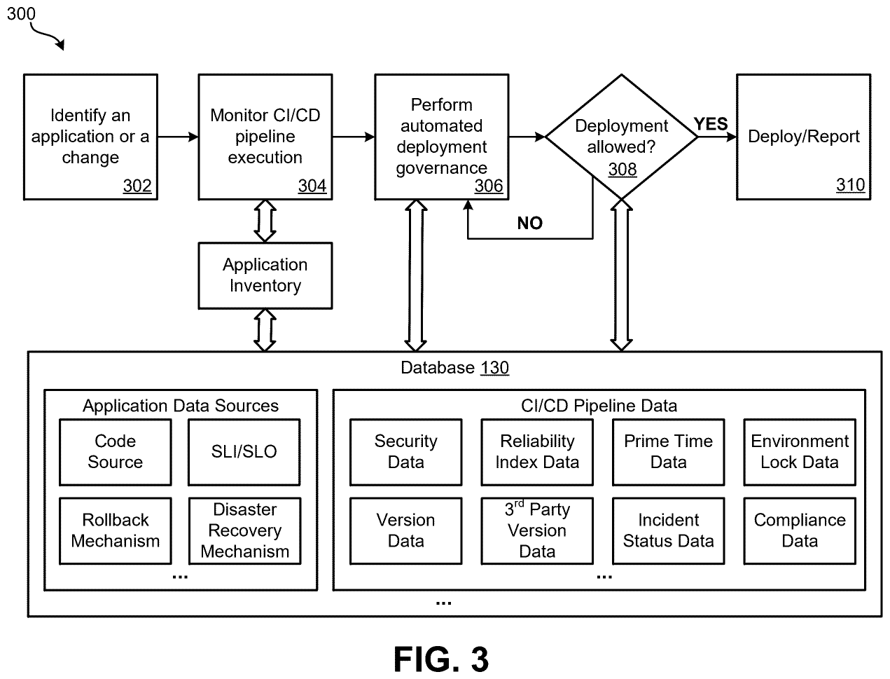

FIG. 3 illustrates an embodiment of a process 300 for deployment of an application by implementation of the deployment management system 104. An application or a change/update of an existing application is identified at 302 through a CI/CD pipeline for the application or change/update. The CI/CD pipeline execution of the application or the change is monitored at 304 to generate various CI/CD pipeline data related to the application or the change/update. The various CI/CD pipeline data may be stored in the database 130. Automated orchestration and governance of the deployment is performed at 306, using the various data stored in the database 130. A decision is made at 308 on whether the application or the change of the application is allowed to release. A release readiness score may be calculated to determine whether the application or the change of the application is ready for release. Various data from the database 106 and database 130 may be utilized in the decision-making at 308. The application or the change of the application is released to and deployed in the production environment at 310, upon a determination that the release readiness score exceeds a predetermined threshold. A report may be generated and sent to the operator. The deployed application or the change of the application is stored in the application inventory. Upon a determination that the release readiness score is below the predetermined threshold and/or critical issues are identified, release of the application or the change is prevented and sent back to the CI/CD pipeline for further development.

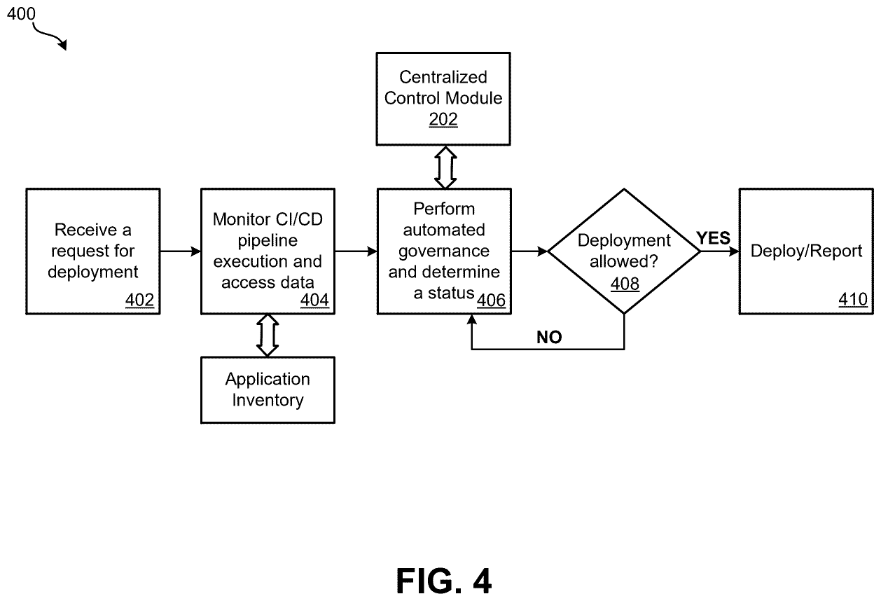

FIG. 4 illustrates an embodiment of a process 400 for automated governance of application deployment by implementing the centralized control module 202. In the illustrated example, a request for change of an application is received in the deployment management system 104 at 402. For example, a change request ticket for changing/updating an application is generated by the ticketing system 160. The CI/CD pipeline execution of the change is initiated and the monitoring of the CI/CD pipeline execution of the change is automatically triggered at 404, and data generated during the CI/CD pipeline execution (e.g., CI/CD pipeline data of the change) is accessed by the centralized control module 202. At 406, the data is analyzed by the centralized control module 202 to determine the readiness of the change/update of the application. At 408, a decision is made on whether the change/update of the application is ready for release. The change of the application is released to and deployed in the production environment at 410, upon a determination that the release readiness score exceeds a predetermined threshold. The centralized control module 202 may further orchestrate the various governance steps performed by one or more modules included in the automated orchestration and governance system 152.

In some embodiments, the change requests can be generated either automatically through the CI/CD pipelines or manually by operators. When a change request is created via the automated CI/CD pipeline, the deployment management system 104 assumes a service account or a predefined role. By identifying the role or account used to create the change request, the deployment management system 104 can determine whether the deployment of the change/update will be automated or manual. This capability allows the deployment management system 104 to track and differentiate between automated and manual deployments. The deployment management system 104 can provide comprehensive analytics to illustrate the proportion of manual versus automated deployments. Based on these insights, the deployment management system 104 can recommend strategies to transition more manual deployments to automated pipelines. Increasing the number of automated deployments enhances centralized control and automated governance of deployment processes, which can improve efficiency, reduce risk of human error, and enhance overall stability in the deployment environment.

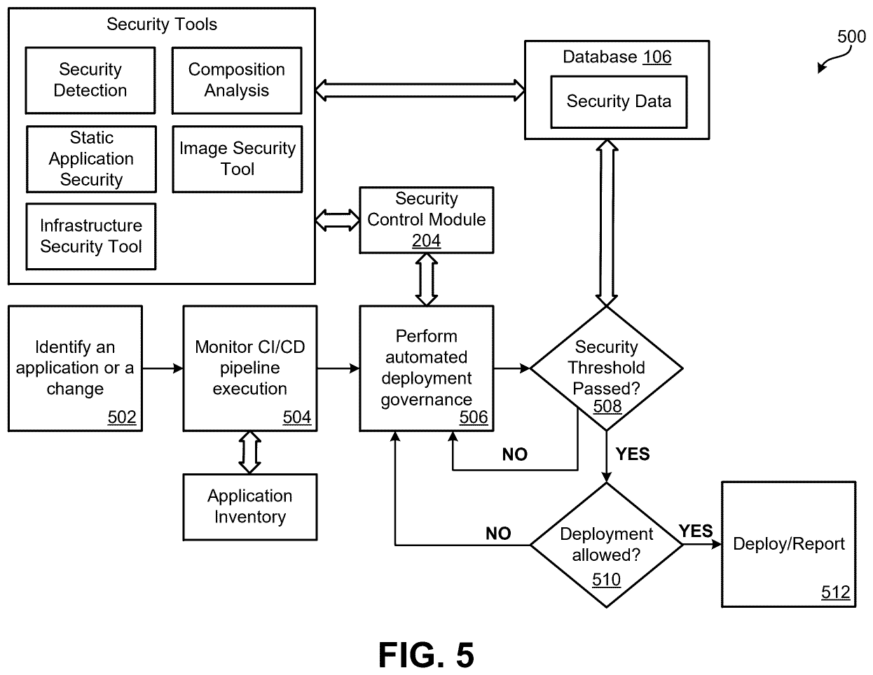

FIG. 5 illustrates an embodiment of a process 500 for automated governance of application deployment by implementing the security control module 204. In the illustrated example, an application or a change of an application is identified at 502. The CI/CD pipeline execution of the change is initiated and the monitoring of the CI/CD pipeline execution of the change is automatically triggered at 504. Various security scan tools integrated into the CI/CD pipeline may be used to perform security scan on the identified application or the change of application. The security scan tools may include secret detection tool, composition analysis tool, static application security tool, image security tool, and infrastructure security tool, among others.

The secret detection tool may be used to identify sensitive information such as passwords, API keys, and tokens that may have been inadvertently included in the source code, scan the codebase for patterns and signatures of secrets, generate alert if any secrets are detected, and prevent the detected secret from being exposed in the application inventory 114 or production environment. The composition analysis tool may be used to analyze the composition of the application, such as dependencies and third-party libraries, to identify known vulnerabilities, examine the software bill of materials (SBOM) and cross-reference with vulnerability databases such as the National Vulnerability Database (NVD) to detect security issues in dependencies. The static application security testing (SAST) tool may be used to detect security vulnerabilities in the source code of the application by analyzing the code to find vulnerabilities without executing it. The image security tool may be used to check the security of container images associated with the application by scanning for vulnerabilities and misconfigurations and analyze the layers of container images to identify vulnerabilities, outdated packages, and insecure configurations. The infrastructure security tool may be used to secure the infrastructure components such as cloud configurations, infrastructure as code (IaC), and network settings.

In some embodiments, the security control module 204 can map the identified vulnerabilities to the specific microservices within the application. Before deployment, the CI/CD pipeline can query the API of the deployment management system 104 to verify the security status of the application. Based on the criticality and severity of identified vulnerabilities, the deployment management system 104 can issue warnings and/or control the block/release of the application to production if critical vulnerabilities remain unaddressed. Various security data may be generated during security scan. The security data may be stored in database 130 for access by the security control module 204.

The security data may be further analyzed by the security control module 204 to determine whether the application or the change of the application passes the security threshold at 506. In some embodiments, a security score is calculated by comparing the security data about the application against a predetermined standard. The application is determined to be secure and ready to proceed to deployment gate if the security score is of or above a predetermined threshold security score. Upon a determination that the application is not secure, the application is sent back to the CI/CD pipeline for further development, and release is prevented. At 508, a decision is made on whether the application of the change/update of application is ready for release. The application or the change of application is released to and deployed in the production environment at 510, upon a determination that the release readiness score exceeds a predetermined threshold. In some embodiments, a security report is generated and presented on a security dashboard at 512. The security report may include the security data, security score, and identified vulnerabilities for the operator to view.

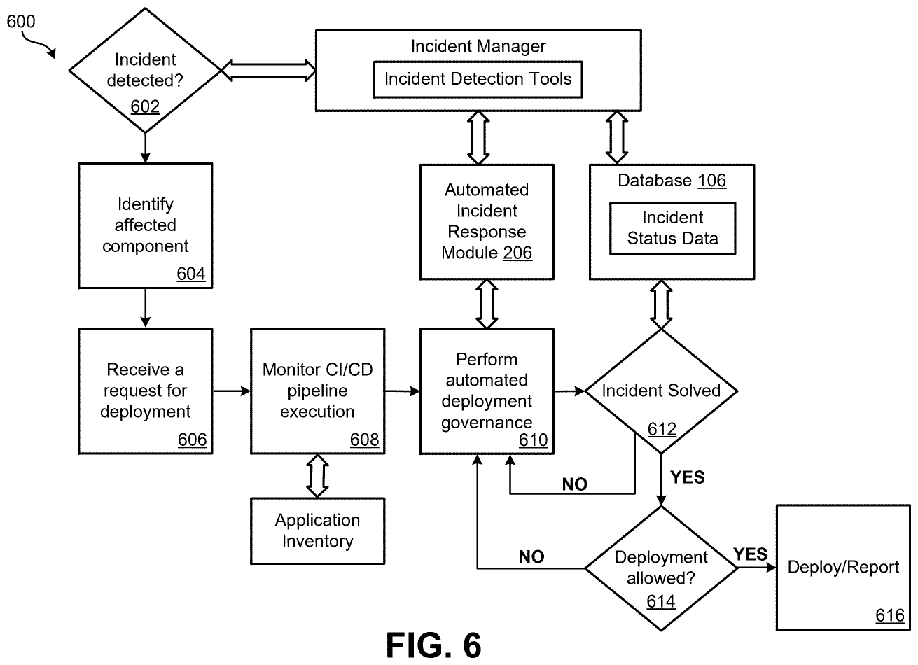

FIG. 6 illustrates an embodiment of a process 600 for automated governance of application deployment by implementing the automated incident response module 206. In the illustrated example, presence or absence of an incident is detected/determined by an incident manager at 602. Various incident management tools may be used to detect incidents and generate incident data. The applications, microservices, services, and infrastructure components that are associated with the incident are identified at 604, by the automated incident response module 206. A request for deployment of change/update of the identified application or a new application related to the identified application is received at 606. The CI/CD pipeline execution of the change/update or the new application is monitored at 608. Automated deployment governance is triggered at 610, and the status of the detected incident (e.g., solved, partially solved, or unresolved) is continuously monitored by the automated incident response module 206. A determination is made on whether the incident is resolved at 612. If the incident is partially resolved or unresolved, a determination is made on whether the new application or the change is impacted by the incident. If the impact exceeds a predetermined threshold, the new application or the change is sent back to the CI/CD pipeline execution for further development. If the incident is resolved or the impact is below the predetermined threshold, the new application or the change is allowed to proceed. At 614, a decision is made on whether the new application or the change/update is ready for release. The new application or the change of application is released to and deployed in the production environment at 616, upon a determination that the release readiness score exceeds a predetermined threshold.

In some embodiments, when the new application is set to deploy at 614, the CI/CD pipeline calls an API (e.g., the communications platform 156) of the deployment management system 104 to request deployment authorization. The automated incident response module 206 will automatically check for any open critical incidents related to the application and fetch incident data about the impact of the incident from the incident management tool. Based on the incident data, the automated incident response module 206 either allows or blocks the deployment from proceeding to production. For instance, if an application is linked to a Severity 1 (Sev 1) incident affecting 100,000 users, the CI/CD pipeline will query the API of the deployment management system 104. Upon detection of the open high-severity, high-impact incident, the automated incident response module 206 will block the deployment and provide the reason for the blockage, such that the release does not proceed while the critical issue remains unresolved. This integration ensures that deployments are managed with full awareness of existing critical issues, preventing further complications and ensuring a stable production environment and enhances overall reliability by enforcing a strict protocol that halts deployments during ongoing critical incidents, thereby safeguarding the user experience and maintaining service integrity.

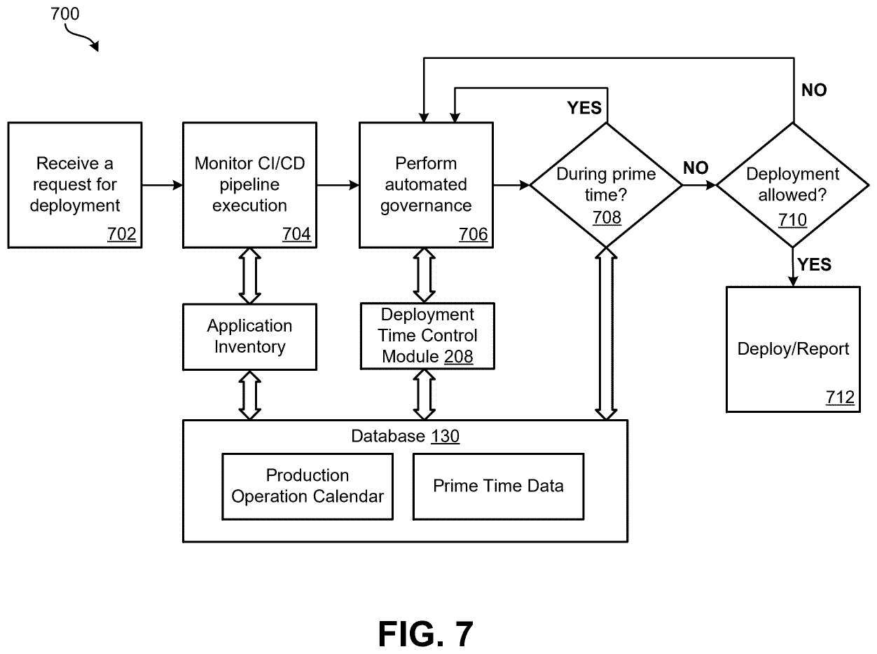

FIG. 7 illustrates an embodiment of a process 700 for automated governance of application deployment by implementing a deployment time control module 208. A request for deploying a new application or a change/update of an application is received at 702. The CI/CD pipeline execution of the application or the change/update is monitored at 704. Automated governance of the deployment is performed at 706, by implementation of the deployment time control module 208 to determine the time when the application or the change/update is set to deploy. At 708, a determination is made on whether the deployment time is during the predetermined prime time. The predetermined prime time may be obtained from the production operation calendar and the prime time data provided in the application data source and managed by the deployment management system 104. If the deployment time is during a predetermined prime time, the application or the change/update is withheld from proceeding to deployment. If the deployment time is not during the prime time, the application or the change/update is allowed to proceed to the deployment gate. At 710, a decision is made on whether the application or the change/update is ready for release. The application or the change/update is released to and deployed in the production environment at 712, upon a determination that the release readiness score exceeds a predetermined threshold.

For example, prime time may be determined based on critical viewership events such as a college football final, an election, or high-traffic holiday seasons like Thanksgiving Holiday or Christmas Holiday. During the time periods, service disruption or viewer experience interruption due to application upgrade is highly undesirable. The deployment time control module 208 is configured to identify the critical events and the corresponding prime time, determine whether the scheduled update (deployment) is within the prime time, and allow/prevent the release of update to production. In some embodiments, when the CI/CD execution pipeline calls the API of the deployment management system 104 to request deployment of an application or a change/update to production, the deployment time control module 208 in response checks for any scheduled critical viewership events and their durations. If such an event is identified, the deployment time control module will block deployment to production for the duration of the event. After the critical event has concluded, the deployment time control module 208 will provide a deployment time window to allow the application or the change/update to be released to deployment without risking service disruption.

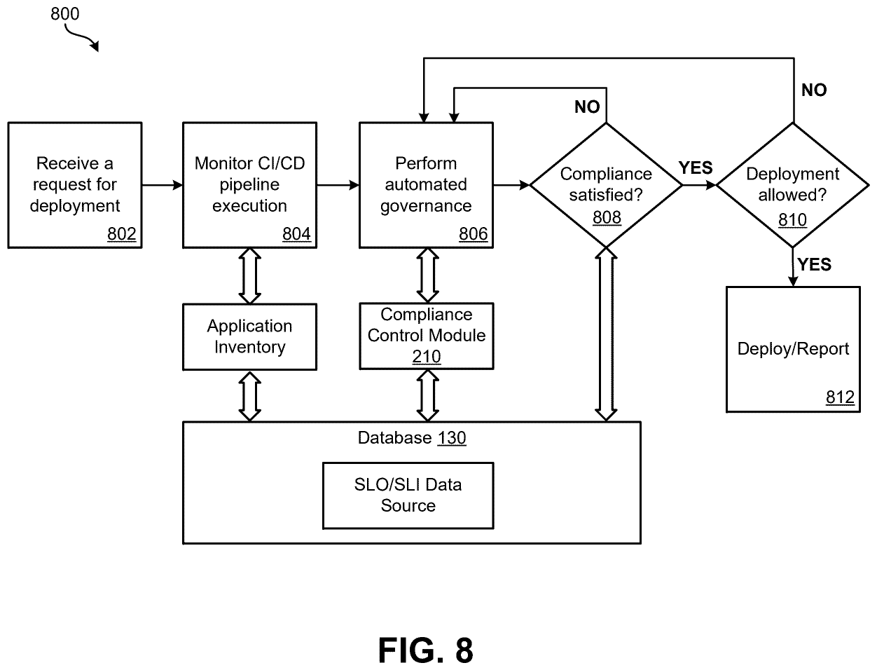

FIG. 8 illustrates an embodiment of a process 800 for monitoring SLO/SLI compliance and automated governance/control of deployment based on SLO/SLI compliance. In the illustrated example, a request for deploying a new application or a change/update of an application is received at 802. The CI/CD pipeline execution of the application or the change/update is monitored at 804. Automated governance of the deployment is performed at 806, by implementation of the compliance control module 210. At 808, a determination is made on whether the to-be-deployed application or change/update complies with the requirements defined by the SLI/SLO. In some embodiments, presence or absence of an SLI/SLO violation is identified, and a compliance/adherence score for the to-be-deployed application is calculated. The compliance requirement may be obtained from the SLI/SLO/SLA provided in the application data source and managed by the deployment management system 104. If the compliance requirements are not satisfied or the compliance/adherence score is below a predetermined threshold, the application or the change/update is withheld from proceeding to deployment. On the other hand, if the compliance requirements are satisfied or the compliance/adherence score exceeds the predetermined threshold, the application or the change/update is allowed to proceed to the deployment gate. At 810, a decision is made on whether the application or the change/update of application is ready for release. The application or the change/update is released to and deployed in the production environment at 812, upon a determination that the release readiness score exceeds a predetermined threshold.

For example, the compliance control module 210 can integrate with the observability of SLI/SLO and govern compliance based on tests of the to-be-deployed application or the update/change carried out in the lower testing environments during CI/CD pipeline execution. The compliance control module 210 can also govern adherence to the SLI/SLO measured during soak tests on a multi cluster deployment environment. If violations are detected and identified, the compliance control module 210 will not allow deployments into production.

Examples of the metrics of SLI/SLO compliance include, but are not limited to, API response time, channel change time, application loading time, latency, and error rate. These metrics are measured using observability tools such as New Relic. The compliance control module 210 is connected to an analytics dashboard of the deployment management system 104 to display SLI/SLO adherence for each microservice within the to-be-deployed application or change/update. The compliance control module 210 also tracks deviations from the defined thresholds for each measurable SLI/SLO performance metrics across all microservices within the to-be-deployed application or change/update. If an identified SLI/SLO violation remains unresolved for a specified period (e.g., a week), the compliance control module 210 will issue a warning for the application when a deployment is attempted. If the SLI/SLO violation persists consistently over the defined period, the compliance control module 210 will, upon receiving an API call in the deployment management system 104 from the CI/CD system 102, validate the adherence level/score of SLIs/SLOs for each microservice within the application or the change/update. If the adherence level/score is under the predetermined threshold, the compliance control module 210 will block the application from deploying to production.

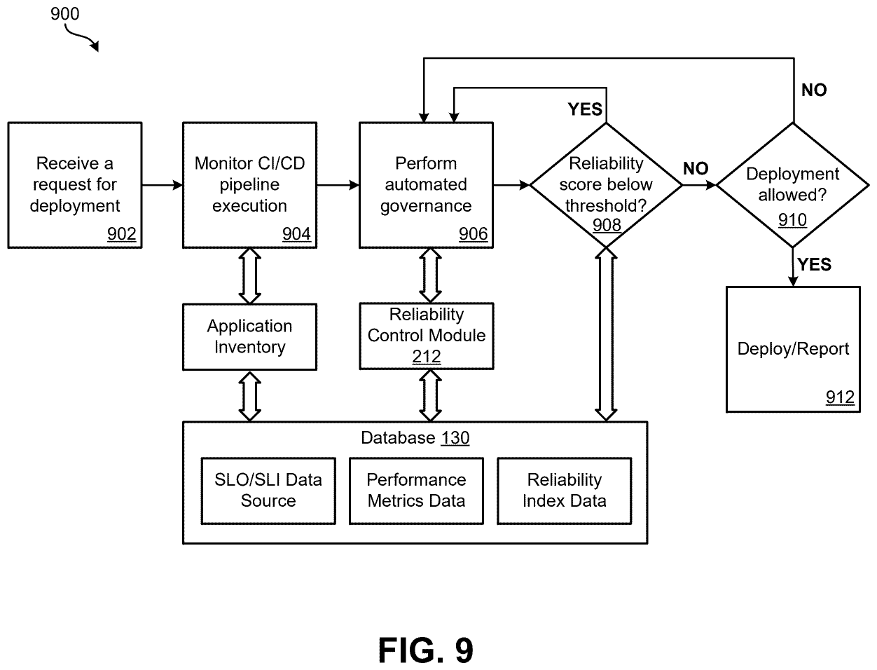

FIG. 9 illustrates an embodiment of a process 900 for automated governance of application deployment by implementing the reliability control module 212. In the illustrated example, a request for deploying a new application or a change/update of an application is received at 902. The CI/CD pipeline execution of the application or the change/update is monitored at 904. Automated governance of the deployment is performed at 906, by implementation of the reliability control module 212. At 908, a determination is made on whether the to-be-deployed application or change/update meets the reliability threshold. In some embodiments, a reliability score is obtained. The reliability score for the to-be-deployed application may be calculated based on the SLI/SLO and performance metrics data provided in the application data source and managed by the deployment management system 104. If the reliability score is below a predetermined threshold, the application or the change/update is withheld from proceeding to deployment. On the other hand, if the reliability score exceeds the predetermined threshold, the application or the change/update is allowed to proceed to the deployment gate. At 910, a decision is made on whether the application or the change/update is ready for release. The application or the change/update is released to and deployed in the production environment at 912, upon a determination that the release readiness score exceeds a predetermined threshold.

For example, the reliability control module 212 can integrate with reliability observability and determine the reliability level (e.g., low, medium, high, etc.) or calculate a reliability index or reliability score. The reliability control module 212 may issue warnings before blocking releases on grounds of low reliability. For example, if the desired reliability (threshold) is 99.99 and the reliability score for the to-be-deployed application is calculated to be 99.95, then the reliability control module 212 will issue warnings three times for reliability <99.99 and at the fourth time the reliability control module 212 will block the release, send the application back to the CI/CD pipeline for further development and testing, and would only allow for a deployment that boosts reliability to 99.99 based on tests in one or more lower environments during CI/CD pipeline execution.

In some embodiments, the reliability control module 212 integrates with an SLI/SLO observability tool to capture and store performance metrics data on a daily basis in the application data source. The reliability control module 212 tracks reliability threshold values, calculates the reliability score, and determines any deviations of the reliability score from these thresholds over time. When an attempt is made to deploy the application, the CI/CD system 102 calls the API of the deployment management system 104, and the reliability control module 212 in response checks for any deviation of the reliability score from the predetermined threshold value. If the reliability score calculated based on the SLI/SLO performance metrics data falls below the predetermined threshold, the reliability control module 212 blocks the deployment to production. For example, if the threshold for the SLO “availability” of a to-be-deployed application is set at 99%, the reliability control module 212 will monitor and store this metric from the observability tool, such as New Relic. If the availability falls below 99%, a violation is identified, and the reliability control module 212 will issue a warning notification. When the deployment is requested, the reliability control module 212 will review the historical SLI/SLO performance metrics data for a predetermined time period (e.g., from the past seven days). If more than three instances of threshold breaches within the time period, the reliability control module 212 will block the release of the application.

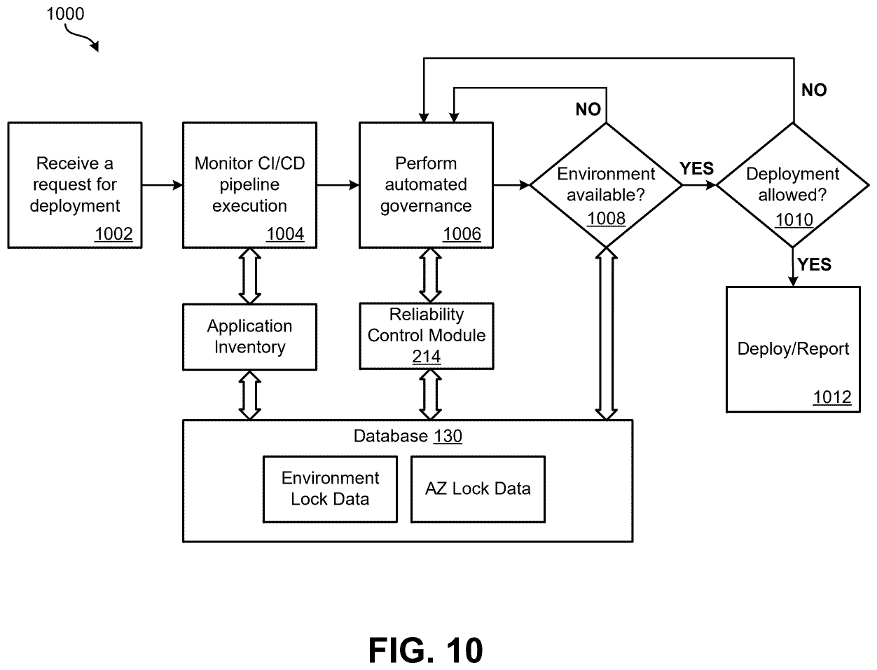

FIG. 10 illustrates an embodiment of a process 1000 for automated governance of application deployment by implementing the environment control module 214. In the illustrated example, a request for deploying a new application or a change/update of an application is received at 1002. The CI/CD pipeline execution of the application or the change/update is monitored at 1004. Automated governance of the deployment is performed at 1006, by implementation of the environment control module 214. At 1008, a determination is made on whether a desired environment or availability zone is available for the deployment of the application or change/update is locked, based on the environment lock data and/or availability zone lock data provided in the application data source. If the desired environment/availability zone is not locked (i.e., not open), the application or the change/update is withheld from proceeding to deployment. On the other hand, if the desired environment/availability zone is not locked, the application or the change/update is allowed to proceed to the deployment gate. At 1010, a decision is made on whether the application or the change/update is ready for release. The application or the change/update is released to and deployed in the desired environment at 1012, upon a determination that the release readiness score exceeds a predetermined threshold. The desired environment may be a production environment or a pre-production environment (i.e., lower environment).

For example, during CI/CD pipeline execution, applications typically go through multiple pre-production environments for deployment and validation before being released to the production environment. The pre-production environments may include development environment, quality assurance (QA) environment, Beta environment (e.g., a non-production environment where the application is made available to a limited audience outside the development and QA teams). If any one of the pre-production or production environments undergoes a maintenance window or encounters an incident that makes it vulnerable or unstable, it is crucial to prevent deployments to avoid failures or inaccurate test results. The environment control module 214 can impose a centralized block on any affected environment. When the CI/CD pipeline attempts to deploy an application to the affected environment, the environment control module 214 in response causes the deployment gate to block the deployment, such that the applications do not experience failures or receive false test results. For example, if the QA environment is scheduled for maintenance or is currently facing an incident, the environment control module 214 will detect the environment lock and block any deployment attempts to the QA environment.

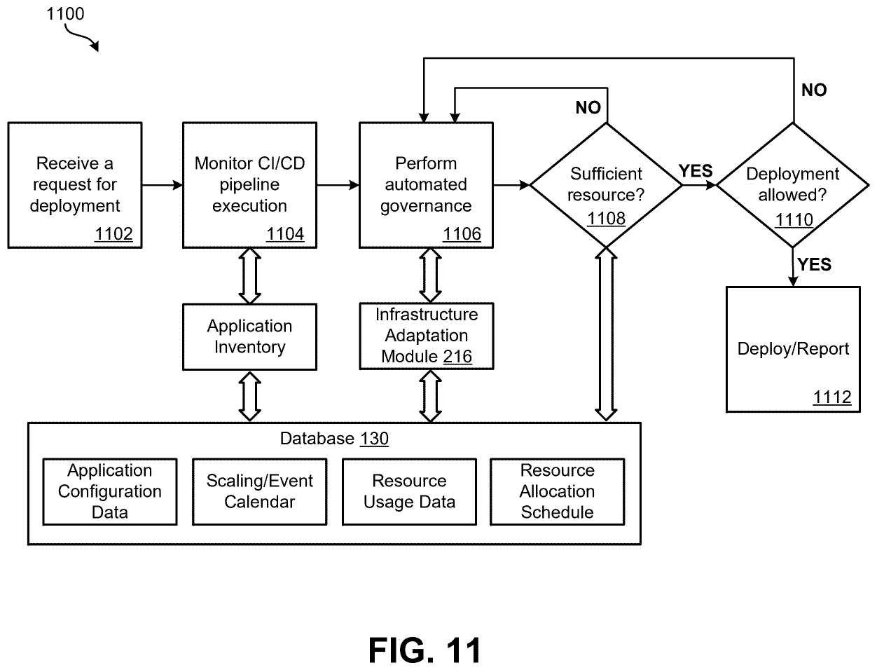

FIG. 11 illustrates an embodiment of a process 1100 for automated governance of application deployment by implementing the infrastructure adaptation module 216. In the illustrated example, a request for deploying a new application or a change/update of an application in a cloud-computing platform is received at 1102. The CI/CD pipeline execution of the application or the change/update is monitored at 1104. Automated governance of the deployment is performed at 1106, by implementation of the infrastructure adaptation module 216. At 1108, a determination is made on whether the available infrastructure resource of the cloud-computing platform is sufficient for the deployment. If the available infrastructure resource is not sufficient, the application or the change/update is withheld from proceeding to deployment. On the other hand, if the available infrastructure resource is sufficient, the application or the change/update is allowed to proceed to the deployment gate. At 1110, a decision is made on whether the application or the change/update of application is ready for release. The application or the change/update is released to and deployed in the production environment supported by sufficient infrastructure resources at 1112, upon a determination that the release readiness score exceeds a predetermined threshold.

In the determination of the availability of sufficient infrastructure resources, various data such as scaling event data, infrastructure resource usage data, resource allocation schedule data, etc., may be retrieved from the database 130 by the infrastructure adaptation module 216. For example, an application requires a 50% scale-up for next deployment, but the current infrastructure cannot support an additional 50% in resources. When this application requests deployment through the deployment governance API, the API of infrastructure adaptation module 216 will verify the scaling configuration defined for the application, retrieve the deployed infrastructure details from the inventory. If the infrastructure adaptation module 216 detects a discrepancy between the scaling configuration and the deployed infrastructure, the infrastructure adaptation module 216 will block the release from entering production and notify the application to update its scaling configuration.

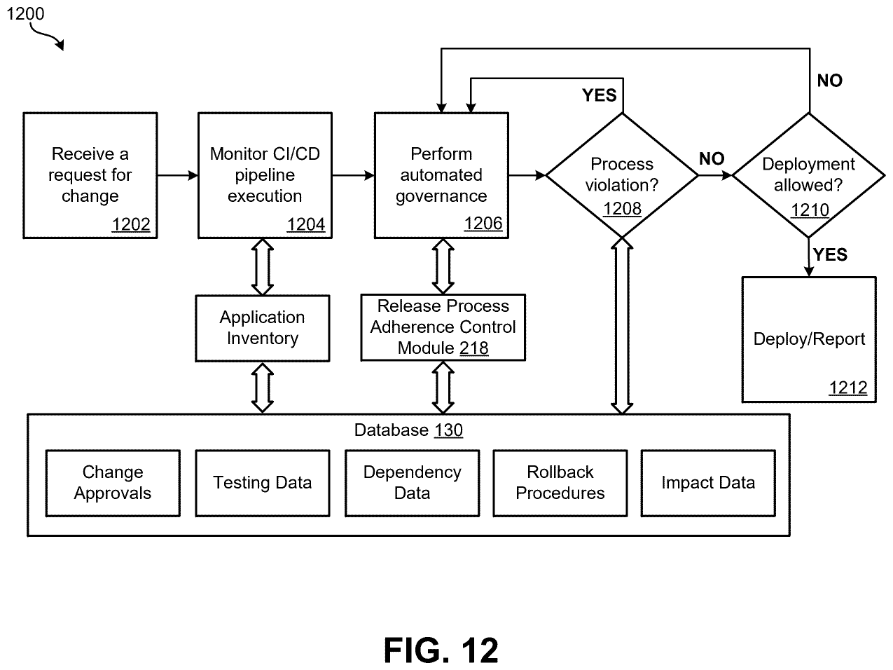

FIG. 12 illustrates an embodiment of a process 1200 for automated governance of application deployment by implementing the release process adherence control module 218. In the illustrated example, a request for deploying a change/update of an application is received at 1202. The CI/CD pipeline execution of the change/update is monitored at 1204. Automated governance of the deployment is performed at 1206, by implementation of the release process adherence control module 218. At 1208, a determination is made on whether a process violation is present or absent. In the presence of a process violation, the change/update is withheld from proceeding to deployment. On the other hand, in the absence of process violation, the change/update is allowed to proceed to the deployment gate. At 1210, a decision is made on whether the change/update of application is ready for release. The change/update is released to and deployed in the production environment at 1212, upon a determination that the release readiness score exceeds a predetermined threshold.

During the determination of a process violation for the to-be-deployed change, the release process adherence control module 218 checks for the change request created in the ticketing tool and validate if all the predefined steps for production deployment like lower environment deployment, validation, details of the change, pre-and post-tests, rollback mechanism and all are well defined and adhered to. Various data from the database 130, such as change approvals, dependency data of the change, testing data of the change, rollback procedures for the change, and impact data for the change, are retrieved and used by the release process adherence control module 218 for determination of the process violation. For example, if Jira is used as a CCB, then the change request should adhere to proper Jira nomenclatures like proper Team and Service component usage, proper labeling of releases. Test results and CI/CD pipeline details are attached to the change request. If the application fails to meet the adherence requirement, a process violation is present.

As another example, a change request requires multiple input fields for successful execution, and the fields include a change plan, rollback plan, lower environment deployment details, validation reports, approver details, monitoring links, among others. The release process adherence control module 218 is integrated with the change management tool, such as Jira, to monitor all created change requests. The release process adherence control module 218 validates each change request to ensure adherence to the defined process and capture all necessary details. When an application is set to deployment, the release process adherence control module 218 scans the associated change request and verifies that all required parameters are present and correct. If the release process adherence control module 218 detects that the change request is missing a change execution plan, rollback plan, or any other critical information, it notifies the user to update the change request with the correct details. The user must then re-execute the CI/CD pipeline for the change after making the necessary updates. Additionally, if the release process adherence control module 218 finds that the attached test results include unresolved bugs, it blocks the release from proceeding to production until revised test results show that the open bugs have been fixed.

Integration of the release process adherence control module 218 to the deployment management system 104 ensures that every change request is thoroughly validated before deployment, reduces the risk of errors, and enhances the reliability of the deployment process. By enforcing strict adherence to change management protocols and ensuring all necessary information is included, the deployment management system 104 maintains high standards for deployment readiness and operational stability.

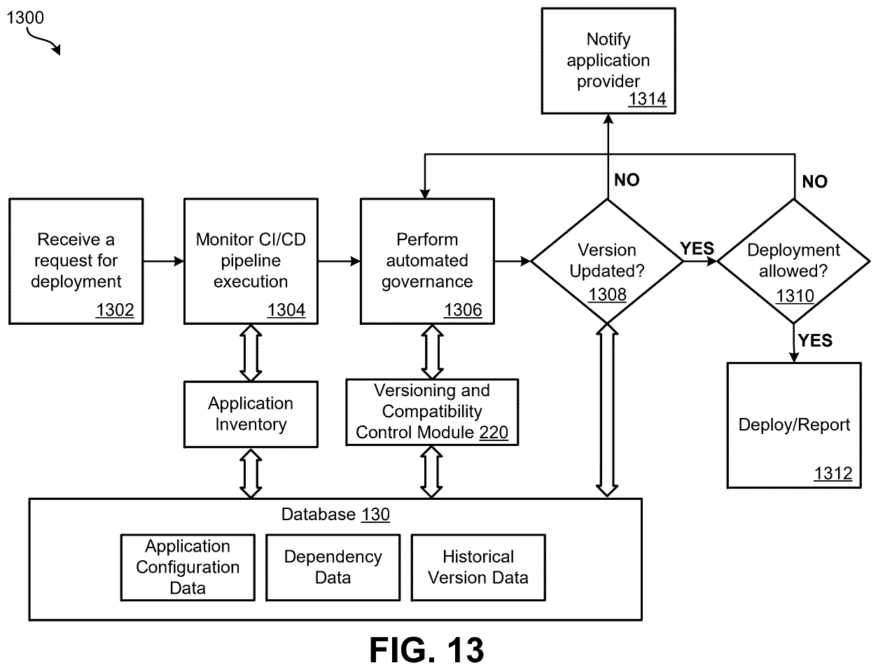

FIG. 13 illustrates an embodiment of a process 1300 for automated governance of application deployment by implementing the versioning and compatibility control module 220. In the illustrated example, a request for deploying an application is received at 1302. The CI/CD pipeline execution of the application is monitored at 1304. Automated governance of the deployment is performed at 1306, by implementation of the versioning and compatibility control module 220. At 1308, a determination is made on whether the version of the application meets a predetermined standard. If the version of the to-be-deployed application does not meet the standard, the application is withheld from proceeding to deployment. In some embodiments, the application provider is notified about the version violation at 1314. On the other hand, if the version meets the standard and no violation is detected, the application is allowed to proceed to the deployment gate. At 1310, a decision is made on whether the application is ready for release. The application is released to and deployed in the production environment at 1312, upon a determination that the release readiness score exceeds a predetermined threshold.

In some embodiments, the to-be-deployed application includes one or more components developed by different teams. The components are versioned and released periodically. The version data of the application and each component thereof is stored in database 130 of the CI/CD pipeline for the application. The versioning and compatibility control module 220 continuously monitors and tracks the versions of the application and the components thereof that are currently in use, based on the application configuration data, dependency data, and historical version data of the application. For example, a component of an application is named ABC, which has a latest stable version X.YY, while the application is using a significantly older version. When the CI/CD execution pipeline requests deployment approval, the versioning and compatibility control module 220 compares the component version used by the application with the latest stable version available. The predetermined standard, for example, may require that the application should not be more than two versions behind the latest stable version. If the versioning and compatibility control module 220 detects that the application is using a version older than the predetermined threshold (e.g., no more than two versions behind the latest stable version), it may notify the application provider to update the component before proceeding with the deployment. Until the component is upgraded to meet the version policy, the versioning and compatibility control module 220 blocks the release from going into production.

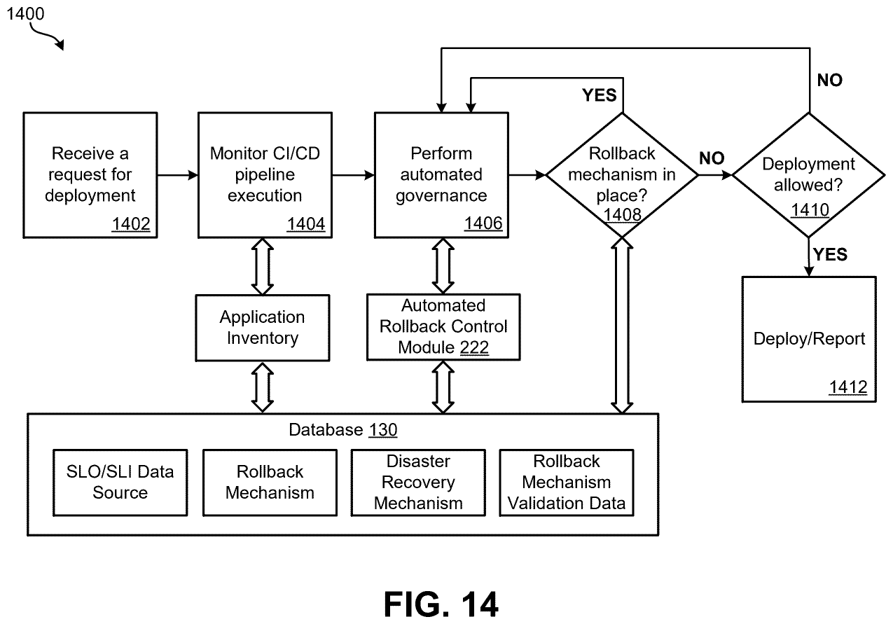

FIG. 14 illustrates an embodiment of a process 1400 for automated governance of application deployment by implementing the automated rollback control module 222. In the illustrated example, a request for deploying an application is received at 1402. The CI/CD pipeline execution of the application is monitored at 1404. Automated governance of the deployment is performed at 1406, by implementation of the automated rollback control module 222. At 1408, a determination is made on the presence or absence of a rollback mechanism for the to-be-deployed application. In some embodiments, a determination is made on whether the rollback mechanism is validated. If no rollback mechanism is present or the rollback mechanism is not validated (e.g., tested and validated in a lower environment), the application is withheld from proceeding to deployment. On the other hand, if the rollback mechanism is present and validated, the application is allowed to proceed to the deployment gate. At 1410, a decision is made on whether the application is ready for release. The application is released to and deployed in the production environment at 1412, upon a determination that the release readiness score exceeds a predetermined threshold.

In some embodiments, upon receiving a request for deployment, the automated rollback control module 222 checks and governs if the application has a rollback mechanism or a disaster recovery mechanism in place. The automated rollback control module 222 assesses the blast radius of the application and for any critical/high impacting deployments if a rollback or disaster recovery mechanism is not in place and tested in a lower environment. The automated rollback control module 222 can access the database 130 to locate the SLO/SLI in the application data sources and check if the rollback mechanism and/or the disaster recovery mechanism are included. The automated rollback control module 222 can also access the test and validation data of the application and determine whether the rollback mechanism and/or the disaster recovery mechanism have been tested and validated in the lower environment.

For example, a streaming service application handles streaming of on demand video content. The application is scheduled for deployment of an update that includes new features aimed at enhancing user experience and security. Before the update can be deployed to the production environment, the automated rollback control module 222 automatically checks for at least two components, a rollback mechanism and a disaster recovery mechanism. The automated rollback control module 222 verifies that the application update includes a reliable rollback mechanism. This rollback mechanism is automatically triggered to cause, in the event the update introduces a fault into the system, the application to be reverted to its previous, stable version without disrupting user transactions.

In some embodiments, the automated rollback control module 222 further checks whether the application has a disaster recovery mechanism that has been tested in lower environments (such as development environment or QA). The disaster recovery mechanism details procedures for restoring service and data integrity in case of a major failure, such as data center outages or catastrophic bugs introduced by the application update. For example, if an update of an application includes changes to the player libraries that are found to be incompatible with certain older browser versions causing video start failures, the disaster recovery mechanism may detail steps to recover from video failures and restore streaming session, while the rollback mechanism may allow the application to be reverted its pre-update state.

Upon a determination that either the rollback mechanism or the disaster recovery mechanism is absent or untested in lower environments, the automated rollback control module 222 assesses the potential “blast radius” (e.g., the extent of impact that an unsuccessful update could have on the overall infrastructure and user base). For example, given the critical nature of video streaming, even a small glitch can impact hundreds of thousands of customers. If the automated rollback control module 222 determines that the application update could lead to significant disruptions and that adequate safeguards are not in place, it will block the release from being deployed to production. This decision remains in force until the necessary rollback and disaster recovery mechanisms are implemented, verified, and validated.

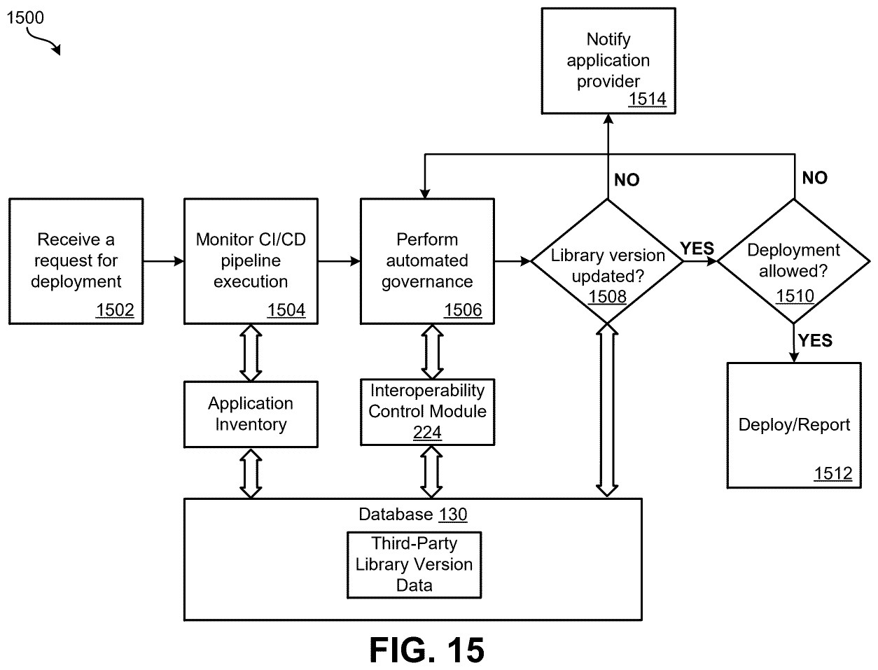

FIG. 15 illustrates an embodiment of a process 1500 for automated governance of application deployment by implementing the interoperability control module 224. In the illustrated example, a request for deploying an application is received at 1502. The CI/CD pipeline execution of the application is monitored at 1504. Automated governance of the deployment is performed at 1506, by implementation of the interoperability control module 224. At 1508, a determination is made on whether the version of a third-party component of the to-be- deployed application is updated or meets a predetermined standard or a threshold level. If the version of the third-party component of the application does not meet the standard, the application is withheld from proceeding to deployment. In some embodiments, the application provider is notified about the version violation at 1514 about the incorrect version. On the other hand, if the version meets the standard and no violation is detected, the application is allowed to proceed to the deployment gate. At 1510, a decision is made on whether the application is ready for release. The application is released to and deployed in the production environment at 1512, upon a determination that the release readiness score exceeds a predetermined threshold.

The interoperability control module 224 continuously tracks and monitors the integration of the application with the third-party components, such as third-party services, third-party APIs, open-source libraries, etc. The interoperability control module 224 can cross compare the third-party components with the latest stable and secure version of the same and issue a warning if the application behind the latest available stable releases by a specific number of generations (e.g., 2 generations behind the latest version). For example, after 3 warnings the interoperability control module 224 will block the release from progressing into production.

For example, an application relies on several third-party APIs and open- source libraries for its functionality. Three open-source libraries, Library 1, Library 2, and Library 3, have following versions Version 1.2.3, Version 3.4.5, and Version 5.6.7, respectively. The interoperability control module 224 continuously monitors the versions of these components and compares them with the latest available stable releases, Latest Version 1.5.0 for Library 1, Latest Version 3.8.0 for Library 2, and Latest Version 5.9.0 for Library 3. The predetermined standard requires that an open-source library of an application should not be more than two versions behind the latest stable release. The interoperability control module 224 detects that Library 1 (current version 1.2.3) is two versions behind the latest (1.5.0). A warning is issued to the application provider (e.g., a development team), indicating the need to update Library 1. This warning is logged, and an alert is sent to the relevant team members. After a predetermined period (e.g., 1 week) elapses from the time of warning, if no action is taken another warning is issued. If no action is taken after the final warning, the interoperability control module 224 will enforce a deployment block to prevent the application from releasing into production. When the CI/CD pipeline of the application attempts to deploy a new version. The interoperability control module 224 checks the versions of Library 1, Library 2, and Library 3. Library 1 is still at version 1.2.3, which is non-compliant. The interoperability control module 224 blocks the deployment.

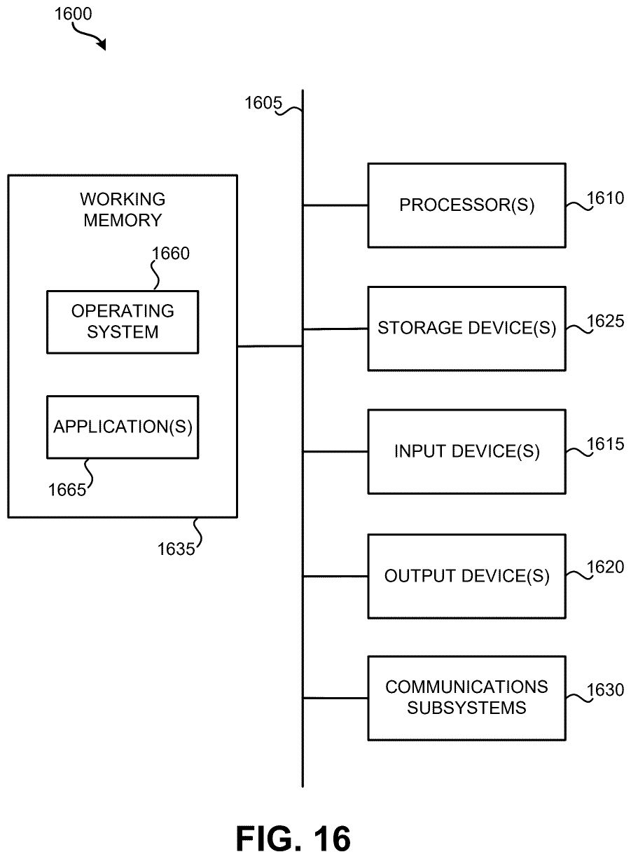

The systems 100 and any components thereof, such as the deployment management system 104, the automated orchestration and governance system 152 and various modules thereof, etc., as described above may include a computer system that further includes computer hardware and software that form special-purpose network circuitry to implement various embodiments such as communication, accessing data, calculation, identification, detection, determination, and other operations or steps of the methods or processes described herein. FIG. 16 is a schematic diagram illustrating an example of computer system 1600. The computer system 1600 is a simplified computer system that can be used to implement various embodiments described and illustrated herein. FIG. 16 provides a schematic illustration of one embodiment of a computer system 1600 that can perform some or all of the steps of the methods and workflows provided by various embodiments. It should be noted that FIG. 7 is meant only to provide a generalized illustration of various components, any or all of which may be utilized as appropriate. FIG. 16, therefore, broadly illustrates how individual system elements may be implemented in a relatively separated or relatively more integrated manner.

The computer system 1600 is shown including hardware elements that can be electrically coupled via a bus 1605, or may otherwise be in communication, as appropriate. The hardware elements may include one or more processors 1610, including without limitation one or more general-purpose processors and/or one or more special-purpose processors such as digital signal processing chips, graphics acceleration processors, and/or the like; one or more input devices 1615, which can include without limitation a mouse, a keyboard, a camera, and/or the like; and one or more output devices 1620, which can include without limitation a display device, a printer, and/or the like.

The computer system 1600 may further include and/or be in communication with one or more non-transitory storage devices 1625, which can include, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 1600 might also include a communications subsystem 1630, which can include without limitation a modem, a network card (wireless or wired), an infrared communication device, a wireless communication device, and/or a chipset such as a Bluetooth™ device, an 802.11 device, a WiFi device, a WiMax device, cellular communication facilities, etc., and/or the like. The communications subsystem 1630 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 1630. In other embodiments, a portable electronic device, e.g., the first electronic device, may be incorporated into the computer system 1600, e.g., an electronic device as an input device 1615. In some embodiments, the computer system 1600 will further include a working memory 1635, which can include a RAM or ROM device, as described above.

The computer system 1600 also can include software elements, shown as being currently located within the working memory 1635, including an operating system 1660, device drivers, executable libraries, and/or other code, such as one or more application programs 1665, which may include computer programs provided by various embodiments, and/or may be designed to implement methods, and/or configure systems, provided by other embodiments, as described herein. Merely by way of example, one or more procedures described with respect to the methods discussed above, such as those described in relation to FIG. 16, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 1625 described above. In some cases, the storage medium might be incorporated within a computer system, such as computer system 1600. In other embodiments, the storage medium might be separate from a computer system e.g., a removable medium, such as a compact disc, and/or provided in an installation package, such that the storage medium can be used to program, configure, and/or adapt a general-purpose computer with the instructions/code stored thereon. These instructions might take the form of executable code, which is executable by the computer system 1600 and/or might take the form of source and/or installable code, which, upon compilation and/or installation on the computer system 1600 e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 1600 to perform methods in accordance with various embodiments of the technology. According to a set of embodiments, some or all of the operations of such methods are performed by the computer system 1600 in response to processor 1610 executing one or more sequences of one or more instructions, which might be incorporated into the operating system 1660 and/or other code, such as an application program 1665, contained in the working memory 1635. Such instructions may be read into the working memory 1635 from another computer-readable medium, such as one or more of the storage device(s) 1625. Merely by way of example, execution of the sequences of instructions contained in the working memory 1635 might cause the processor(s) 1610 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 1600, various computer-readable media might be involved in providing instructions/code to processor(s) 1610 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 1625. Volatile media include, without limitation, dynamic memory, such as the working memory 1635.

Common forms of physical and/or tangible computer-readable media include, for example, a floppy disk, a flexible disk, hard disk, magnetic tape, or any other magnetic medium, a CD-ROM, any other optical medium, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 1610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1600.

The communications subsystem 1630 and/or components thereof generally will receive signals, and the bus 1605 then might carry the signals and/or the data, instructions, etc. carried by the signals to the working memory 1635, from which the processor(s) 1610 retrieves and executes the instructions. The instructions received by the working memory 1635 may optionally be stored on a non-transitory storage device 1625 either before or after execution by the processor(s) 1610.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Various aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer- readable medium such as a storage medium. Processors may perform the described tasks.

As used herein and in the appended claims, the singular forms “a”, “an”, and “the” include plural references unless the context clearly dictates otherwise. Thus, for example, reference to “a test case” includes a plurality of such test cases, and reference to “the processor” includes reference to one or more processors and equivalents thereof known in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A computer system comprising:
one or more processors; and
a computer-readable storage media storing computer-executable instructions, wherein, the instructions when executed by the one or more processors, cause the computer system to:
receive a request for deploying an application in a production environment;
access data generated during continued integration/continued development (CI/CD) pipeline execution of the application;
analyze the data to determine a status of the application;
determine whether the application is ready for deployment based at least in part on the status of the application and a predetermined policy; and
block the application from deployment into the production environment in response to a determination that the application is not ready.

2. The computer system of claim 1, wherein the data comprises security scan results of the application, the status of the application indicates a security score determined based on the security scan results, and the application is determined not ready for deployment if the security score does not meet a threshold specified in the predetermined policy.

3. The computer system of claim 1, wherein the data comprises incident data indicating presence or absence of an incident open to resolution in the production environment, the status of the application indicates whether the incident is solved or not and whether the application is related to the incident, and the application is determined not ready for deployment if the application is related to the incident and the incident is not resolved.

4. The computer system of claim 1, wherein the data comprises prime time data indicating a predetermined prime time during production operation, the status of the application indicates whether a scheduled deployment time of the application is within the predetermined prime time, and the application is determined not ready for deployment if the scheduled deployment time of the application is within the predetermined prime time.

5. The computer system of claim 1, wherein the data comprises service level objective (SLO) or service level indicator (SLI) of the application and test data generated from testing of the application in one or more pre-production environments during the CI/CD pipeline execution of the application, the status of the application indicates a compliance level of the application against the SLO/SLI based on the test data, and the application is determined not ready for deployment if the compliance level meets a threshold level specified in the predetermined policy.

6. The computer system of claim 1, wherein the data comprises environment lock data indicating a predetermined time window when the production environment is locked for deployment, the status of the application indicates whether a scheduled deployment time of the application is within the predetermined time window, and the application is determined not ready for deployment if scheduled deployment time of the application is within the predetermined time window.

7. The computer system of claim 1, wherein the production environment is established on a cloud-computing infrastructure, the data comprises resource usage data indicating a current availability level of infrastructure resource of the cloud-computing infrastructure, the status of the application indicates a minimum level of infrastructure resource desired for the application based on the predetermined policy, and the application is determined not ready for deployment if the current availability level of infrastructure resource does not meet the minimum level.

8. The computer system of claim 1, wherein the predetermined policy specifies required steps of the CI/CD pipeline execution of the application, and the application is determined not ready for deployment if the status of the application indicates that not all of the required steps are completed.

9. The computer system of claim 1, wherein the data comprises version data indicating a current version of each one of one or more components of the application and a latest stable version of the component, the status of the application indicates a difference between the current version and the latest stable version for each one of the one or more components, and the application is determined not ready for deployment if the difference is more than a predetermined number of versions specified in the predetermined policy.

10. The computer system of claim 1, wherein the data comprises SLO/SLI of the application and test data of the application, the status of the application indicates presence or absence of a rollback mechanism applicable to the application based on the SLO/SLI and whether the rollback mechanism has been validated based on the test data, and the application is determined not ready for deployment if the rollback mechanism is absent or if the rollback mechanism has not been validated.

11. A method for automated governance of application deployment, the method comprising:
receiving, in an automated deployment management system, a request for deploying an application in a production environment;
accessing, by the automated deployment management system, data generated during continued integration/continued development (CI/CD) pipeline execution of the application,
analyzing, by the automated deployment management system, the data to determine a status of the application;
determining, by the automated deployment management system, whether the application is ready for deployment based at least in part on the status of the application and a predetermined policy; and
blocking, by the automated deployment management system, the application from deployment into the production environment in response to a determination that the application is not ready.

12. The method of claim 11, wherein the data comprises security scan results of the application, the status of the application indicates a security score determined based on the security scan results, and the application is determined not ready for deployment if the security score does not meet a threshold specified in the predetermined policy.

13. The method of claim 11, wherein the data comprises incident data indicating presence or absence of an incident open to resolution in the production environment, the status of the application indicates whether the incident is solved or not and whether the application is related to the incident, and the application is determined not ready for deployment if the application is related to the incident and the incident is not resolved.

14. The method of claim 11, wherein the data comprises prime time data indicating a predetermined prime time during production operation, the status of the application indicates whether a scheduled deployment time of the application is within the predetermined prime time, and the application is determined not ready for deployment if the scheduled deployment time of the application is within the predetermined prime time.

15. The method of claim 11, wherein the data comprises service level objective (SLO) or service level indicator (SLI) of the application and test data generated from testing of the application in one or more pre-production environments during the CI/CD pipeline execution of the application, the status of the application indicates a compliance level of the application against the SLO/SLI based on the test data, and the application is determined not ready for deployment if the compliance level meets a threshold level specified in the predetermined policy.

16. The method of claim 11, wherein the data comprises environment lock data indicating a predetermined time window when the production environment is locked for deployment, the status of the application indicates whether a scheduled deployment time of the application is within the predetermined time window, and the application is determined not ready for deployment if scheduled deployment time of the application is within the predetermined time window.

17. The method of claim 11, wherein the production environment is established on a cloud-computing infrastructure, the data comprises resource usage data indicating a current availability level of infrastructure resource of the cloud-computing infrastructure, the status of the application indicates a minimum level of infrastructure resource desired for the application based on the predetermined policy, and the application is determined not ready for deployment if the current availability level of infrastructure resource does not meet the minimum level.

18. The method of claim 11, wherein the predetermined policy specifies required steps of the CI/CD pipeline execution of the application, and the application is determined not ready for deployment if the status of the application indicates that not all of the required steps are completed.

19. The method of claim 11, wherein the data comprises version data indicating a current version of each one of one or more components of the application and a latest stable version of the component, the status of the application indicates a difference between the current version and the latest stable version for each one of the one or more components, and the application is determined not ready for deployment if the difference is more than a predetermined number of versions specified in the predetermined policy.

20. The method of claim 11, wherein the data comprises SLO/SLI of the application and test data of the application, the status of the application indicates presence or absence of a rollback mechanism applicable to the application based on the SLO/SLI and whether the rollback mechanism has been validated based on the test data, and the application is determined not ready for deployment if the rollback mechanism is absent or if the rollback mechanism has not been validated.
